(19) United States
(12) Patent Application Publication
(10) Pub. No.: US 2007/0157772 A1
(43) Pub. Date: Jul. 12, 2007

(54) Mechanical tool coupler

(76) Inventor: Kenneth R. Parker, Waxhaw, NC (US)

Correspondence Address: Schwartz Law Firm, P.C.;SouthPark Towers, Suite 530, 6100 Fairview Road, Charlotte, NC, 28210, US

(21) Appl. No.: 11/330,410

(22) Filed: Jan. 10, 2006

(51) Int. Cl. B25B 23/16; B25G 1/00; B25G 1/04

(52) U.S. Cl. 81/177.85; 81/177.2

(57) ABSTRACT

A mechanical tool coupler is adapted for operatively interconnecting first and second elongated hand tools arranged end to end. The first and second hand tools combine to form an extended tool assembly having a first free end adapted for engaging a head of a threaded fastener, and a second free end adapted for receiving a force applied by a user. The mechanical tool coupler includes first and second attached coupler heads. The first coupler head has adjacent intersecting sides defining a respective plurality of points. The first coupler head is adapted for receiving a proximal end of the first hand tool. A second coupler head has adjacent intersecting sides which define a respective plurality of points. The second coupler head extends opposite the first coupler head and is adapted for receiving a proximal end of the second hand tool.

### TECHNICAL FIELD AND BACKGROUND OF THE INVENTION

This invention relates to a mechanical tool coupler. The invention is applicable for quickly and conveniently interconnecting a number of elongated hand tools, such as standard wrenches, end to end to create an extended tool assembly designed for engaging and rotating a threaded fastener. The invention provides increased leverage and reach when inserting/removing the fastener from a complementary-threaded opening. The invention is especially applicable for use in industries, such as automotive repair and plumbing, which require the manipulation of threaded nuts and fasteners in tight areas.

### SUMMARY OF INVENTION

Therefore, it is an object of the invention to provide a mechanical tool coupler which is applicable for interconnected multiple hand tools end to end.

It is another object of the invention to provide a mechanical coupler which quickly and conveniently combines hand tools for an extended reach.

It is another object of the invention to provide a mechanical coupler which quickly and conveniently combines hand tools for increased leverage.

It is another object of the invention to provide a mechanical coupler which is applicable for combining different types of hand tools.

It is another object of the invention to provide an extended tool assembly.

It is another object of the invention to provide a method for manipulating a threaded fastener.

These and other objects of the present invention are achieved in the preferred embodiments disclosed below by providing a mechanical tool coupler adapted for operatively interconnecting first and second elongated hand tools arranged end to end. The first and second hand tools combine to form an extended tool assembly having a first free end adapted for engaging a head of a threaded fastener, and a second free end adapted for receiving a force applied by a user. The mechanical tool coupler includes first and second attached coupler heads. The first coupler head has adjacent intersecting sides defining a respective plurality of points. The first coupler head is adapted for receiving a proximal end of the first hand tool. A second coupler head has adjacent intersecting sides which define a respective plurality of points. The second coupler head extends opposite the first coupler head and is adapted for receiving a proximal end of the second hand tool.

According to another preferred embodiment of the invention, a divider is located between the first and second coupler heads.

According to another preferred embodiment of the invention, the divider is a generally flat disk.

According to another preferred embodiment of the invention, the disk has an annular peripheral edge which extends beyond respective points of the first and second coupler heads.

According to another preferred embodiment of the invention, the first coupler head has at least three spaced-apart points.

According to another preferred embodiment of the invention, the second coupler head has at least three spaced-apart points.

According to another preferred embodiment of the invention, the first and second coupler heads are substantially identical.

According to another preferred embodiment of the invention, the first and second coupler heads reside in axial alignment.

In another embodiment, the invention is an extended tool assembly. The tool assembly includes first and second elongated hand tools arranged end to end, and having a first free end adapted for engaging a threaded fastener and a second free end adapted for receiving a force applied by a user. A mechanical tool coupler interconnects the first and second hand tools. The tool coupler includes first and second attached coupler heads. The first coupler head has adjacent intersecting sides defining a respective plurality of points. The first coupler head is adapted for receiving a proximal end of the first hand tool. The second coupler head has adjacent intersecting sides defining a respective plurality of points. The second coupler head extends opposite the first coupler head, and is adapted for receiving a proximal end of the second hand tool.

According to another preferred embodiment of the invention, the first and second hand tools comprise wrenches.

In yet another embodiment, the invention is a method for manipulating a threaded fastener which resides within a complementary-threaded opening. The method includes the steps of positioning a free end of a first elongated hand tool on a head of the threaded fastener, and releasably joining a proximal end of the first hand tool to a proximal end of a second hand tool. A manual force is then applied to a free end of the second hand tool to pivot the joined first and second hand tools relative to a point defined by the head of the fastener, thereby manipulating the threaded fastener.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of a mechanical tool coupler according to one preferred embodiment of the present invention;

FIG. 2 is a side view of the mechanical tool coupler;

FIG. 3 is an end view of the mechanical tool coupler;

FIG. 4 is a side view of an extended tool assembly according to one preferred embodiment of the present invention, and showing the mechanical tool coupler joining respective proximal ends of the hand tools; and

FIG. 5 is a side view the extended tool assembly according to another preferred embodiment of the present invention, and showing the mechanical tool coupler joining respective proximal ends of the hand tools.

### DESCRIPTION OF THE PREFERRED EMBODIMENT AND BEST MODE

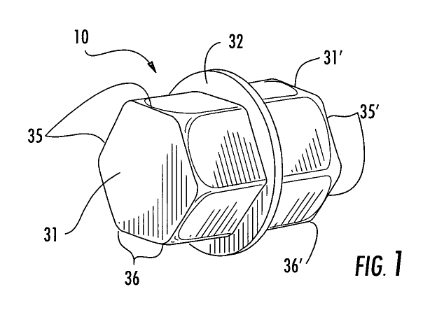

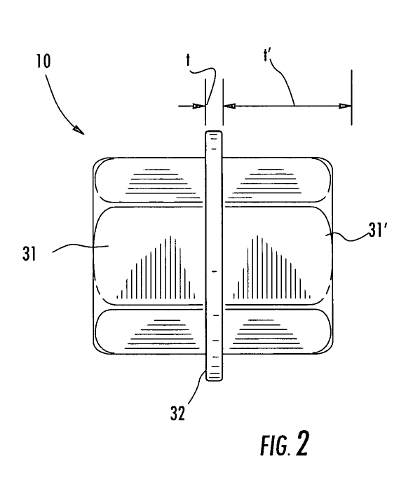

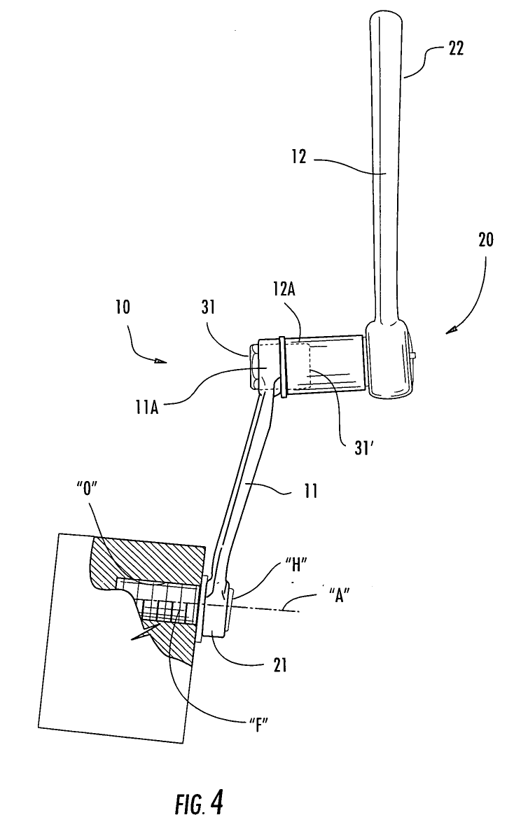

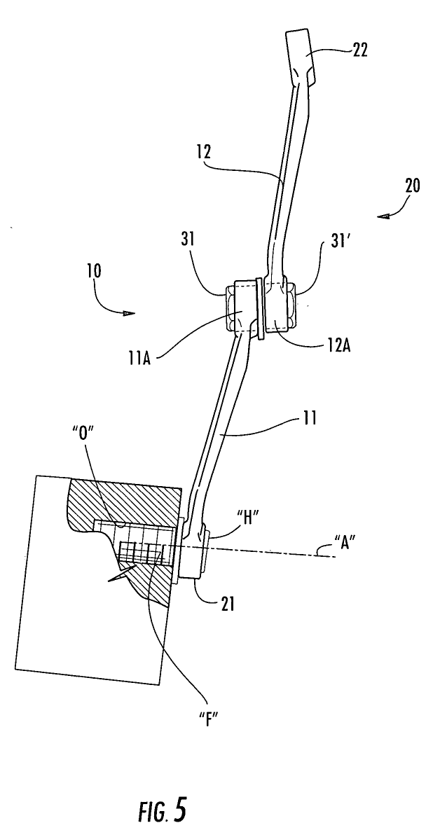

Referring now specifically to the drawings, a mechanical tool coupler according to the present invention is illustrated in FIGS. 1-3, and shown generally at reference numeral 10. The tool coupler 10 is especially applicable for use in combination with two or more hand tools, such as open-end wrenches, closed-end wrenches, socket wrenches, and the like. For example, FIGS. 4 and 5 demonstrate use of the tool coupler 10 with a socket wrench/closed-end wrench combination and two closed-end wrenches, respectively. Other desired tool combinations not shown are likewise operable.

As shown in FIGS. 4 and 5, the tool coupler 10 releasably joins the hand tools 11 and 12 at their respective proximal ends 11A, 12A to form an extended, rigid tool assembly 20. The tool assembly 20 has a first free end 21 for being applied to the head “H” of a threaded fastener “F”, and an opposite second free end 22 for being grasped by a user. By applying force to the free end 22, the user can more easily pivot the tool assembly 20 and fastener “F” in a clockwise or counterclockwise direction relative to a notional axis “A” (extending along a length of the fastener). The extended tool assembly 20 allows increased leverage on the fastener “F” to facilitate its entry into or removal from a complementary threaded opening “O”.

Referring again to FIGS. 1-3, the tool coupler 10 comprises first and second solid metal coupler heads 31, 31′ extending in precise axial alignment, and separated by a thin metal disk 32. Each coupler head 31, 31′ has adjacent intersecting sides 35, 35′ defining respective points 36, 36′ of engagement, such as those found on standard nuts, bolt heads, and other hardware. According to one embodiment, the coupler heads 31, 31′ are identical and have sides 35, 35′ forming at least three points 36, 36′. In the embodiment shown, both heads 31, 31′ have six sides forming six points of engagement. The dividing disk 32 preferably has a thickness (t) less than one-fourth the thickness (t′) of either head 31, 31′, and is more preferably about one-eighth the thickness of either head.

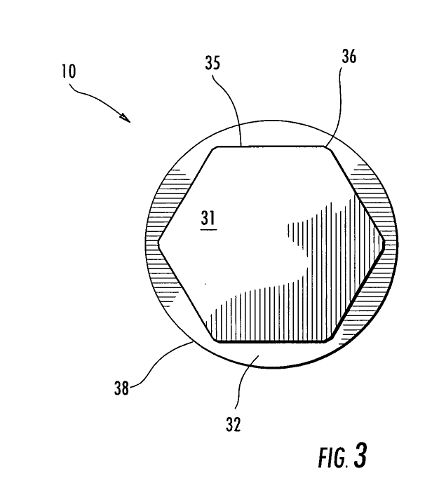

The coupler head 31 is designed for receiving the proximal end 11A of the first hand tool 11, while the second coupler head 31′ receives the proximal end 12A of the second hand tool 12, as shown in FIGS. 4 and 5. The dividing disk 32 serves to properly locate both tools 11, 12 on their respective coupler heads 31, 31′, such that neither tool 11, 12 engages more or less of the coupler 10 than the other. Preferably, the disk 32 has an annular peripheral edge 38 (FIG. 3) which extends beyond the points 36, 36′ of each head 31, 31′.

A mechanical tool coupler, extended tool assembly, and method for manipulating a threaded fastener are described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

1. A mechanical tool coupler adapted for operatively interconnecting first and second elongated hand tools arranged end to end, such that the first and second hand tools combine to form an extended tool assembly having a first free end adapted for engaging a head of a threaded fastener, and a second free end adapted for receiving a force applied by a user, said mechanical tool coupler comprising:
a first solid coupler head comprising adjacent intersecting sides defining a respective plurality of points, said first coupler head adapted for receiving a proximal end of the first hand tool; and
a second solid coupler head of a size, shape, and orientation identical to said first coupler head and comprising adjacent intersecting sides defining a respective plurality of points, said second coupler head extending in axial alignment with and opposite the first coupler head and adapted for receiving a proximal end of the second hand tool; and
a divider located between said first and second coupler heads.

2. (canceled)

3. A mechanical tool coupler according to claim 1, wherein said divider comprises a generally flat disk.

4. A mechanical tool coupler according to claim 3, wherein said disk has an annular peripheral edge which extends beyond respective points of said first and second coupler heads.

5. A mechanical tool coupler according to claim 1, wherein each of said first coupler head and said second coupler head comprises at least three spaced-apart points.

6. (canceled)

7. (canceled)

8. (canceled)

9. An extended tool assembly comprising first and second elongated hand tools arranged end to end, and having a first free end adapted for engaging a threaded fastener and a second free end adapted for receiving a force applied by a user, a mechanical tool coupler interconnecting said first and second hand tools, and comprising:
a first solid coupler head comprising adjacent intersecting sides defining a respective plurality of points, said first coupler head adapted for receiving a proximal end of the first hand tool; and
a second solid coupler head of a size, shape, and orientation identical to said first coupler head and comprising adjacent intersecting sides defining a respective plurality of points, said second coupler head extending in axial alignment with and opposite the first coupler head and adapted for receiving a proximal end of the second hand tool; and
a divider located between said first and second coupler heads.

10. (canceled)

11. An extended tool assembly according to claim 9, wherein said divider comprises a generally flat disk.

12. An extended tool assembly according to claim 11, wherein said disk has an annular peripheral edge which extends beyond respective points of said first and second coupler heads.

13. An extended tool assembly according to claim 9, wherein each of said first coupler head and said second coupler head comprises at least three spaced-apart points.

14. (canceled)

15. (canceled)

16. (canceled)

17. An extended tool assembly according to claim 9, wherein said first and second hand tool comprise wrenches.

18. (canceled)
